(19) United States
(12) Patent Application Publication
(10) Pub. No.: US 2002/0011099 A1
(43) Pub. Date: Jan. 31, 2002

(54) Crankshaft drive sensor

(76) Inventors: Gunter Domens, Holzkirchen (DE); Hong Zhang, Tegernheim (DE)

Correspondence Address: LERNER AND GREENBERG, P.A., Post Office Box 2480, Hollywood, FL, 33022-2480, US

(21) Appl. No.: 09/781,177

(22) Filed: Feb. 12, 2001

(30) Foreign Application Priority Data
Feb. 11, 2000 (DE) 100 06 235.0

(51) Int. Cl. G01L 3/26

(52) U.S. Cl. 73/117.3

(57) ABSTRACT

The crankshaft drive sensor has: at least one force sensor, mounted on a push rod, for measuring a rod force, at least one measured value transmitter by means of which a measurement signal of the force sensor can be transmitted in a contactless fashion, and an angle sensor for determining a crank angle of a crank connected to the push rod.

### BACKGROUND OF THE INVENTION

1. Field of the Invention

The invention relates to a crankshaft drive sensor and to method of using the crankshaft drive sensor.

A general crankshaft drive, for example for use as a propulsion unit, is described in Dubbel; Taschenbuch fur den Maschinenbau [Machine engineering pocket book], 18th edition, Springer [publishing house], 1995, pp 163 to 168.

Cylinder-specific monitoring of the energy conversion process using sensors will increasingly make an important contribution to optimizing the efficiency and the smooth running of an internal combustion engine. Hitherto, attempts have been made to utilize the measurement of the combustion chamber pressure in the individual cylinders as input variables for optimizing the characteristics of the drive train. However, long-term stability of the pressure sensors is critical because of the high temperature in the combustion chamber and requires cost-intensive measures which prevent appropriate series-manufactured products from being made available.

Furthermore, the torque output by the engine will also constitute an important input variable for performing monitoring and control of the entire drive train. For this purpose, hitherto attempts have been made to use a torque measurement based on the torsion of a flex plate as an input variable because the torque which is output cannot be calculated from the individual pressure profiles with sufficient precision. The necessary direct measurement of the flex plate is also costly because of the geometric and structural peripheral conditions.

### SUMMARY OF THE INVENTION

It is accordingly an object of the invention to provide a method for sensing input variables when monitoring and controlling crankshaft drives, in particular in the case of an internal combustion engine and/or a drive train driven by it which overcomes the above-mentioned disadvantageous of the prior art methods of this general type.

It is also accordingly an object of the invention to provide a crankshaft drive sensor which overcomes the above-mentioned disadvantageous of the prior art apparatus this general type.

With the foregoing and other objects in view there is provided, in accordance with the invention a crankshaft drive sensor that includes at least one force sensor mounted on a push rod for measuring a rod force. The force sensor provides a measurement signal. The crankshaft drive sensor includes at least one measured value transmitter for transmitting the measurement signal of the force sensor in a contactless manner, and an angle sensor for determining a crank angle of a crank connected to the push rod.

The crankshaft drive sensor is based on the principle that it has at least one force sensor for measuring a (push) rod force Fp along a push rod, which force sensor is mounted on the push rod. The push rod generally converts an oscillating movement of a piston into a rotary movement of a crank.

Furthermore, an angle sensor by means of which a crank angle φ of the crank can be determined is provided. For example, an inductive or optical angle sensor may be used. The crank angle φ does not need to be measured directly by the angle sensor but rather can also be determined indirectly by means of the position of other components connected to the push rod.

In addition, a measured value transmitter which transmits the measured values recorded by the force sensor in a contactless fashion is provided. This is necessary because the push rod moves as a rule at a high speed, for example 6000 rpm, and with a large displacement, for example 50 mm-80 mm. The measurement signals emitted by the measured value transmitter are typically registered by a detector and further processed, if appropriate, by means of an evaluation unit.

This crankshaft drive sensor can be used to sense various important control variables of a crankshaft drive easily and reliably. In particular, the torque Md acting on the crank can be determined.

The crankshaft drive sensor can be applied in general thrust cranks, for example on a hydraulic or piezoelectric drive, in particular in a crank drive of an internal combustion engine.

In the internal combustion engine, given, for example, knowledge of the rod force Fp and of the crank angle φ, it is possible to determine inter alia, the following control variables:

the tangential force component Ft of the rod force Fp on the crank, the cylinder-specific torque Md being obtained as a product of Ft and the crank radius r,

the cylinder-specific force Fs and the pressure pB=Fs/Ak in the combustion chamber taking into account the acceleration of the push rod,

the instantaneous overall torque,

the cylinder-specific engine torque loss (friction+throttle loss),

the overall engine torque loss,

the cylinder-specific gas torque (induced torque due to combustion), and

the profile of the combustion chamber pressure pB for detecting misfires, for controlling smooth running, for controlling the point of maximum combustion, etc.

In this way, the crankshaft drive sensor can be used to derive directly virtually all contol variables which according to contemporary criteria are of particular significance for engine control. For example, the adaptation of the torque loss model can be carried out on the basis of the engine torque loss. The torque model can be adapted on the basis of the induced torque. Safety monitoring can be carried out in an emission control system on the basis of the measured clutch torque.

The force sensor must also fulfill high requirements in terms of durability and reliability because of a typical high load cycle coefficient (approximately 10¹⁰). The force sensor should also be generally high-temperature resistant up to approximately 150° C., for example when used in an internal combustion engine.

In such a case, it is possible to mount just one high-quality force sensor or a system of a plurality of force sensors on the push rod in order to encourage precision and operating reliability.

It may be advantageous to use an extension sensor as force sensor, it being possible to determine the rod force Fp from a measurement of the extension in the longitudinal direction of the push rod in conjunction with its cross section and the modulus of elasticity E. Here, it is particularly advantageous if a strain gage which is applied by vapor deposition, in particular a high-temperature strain gage, is used as extension sensor. A piezoresistive or capacitive extension sensor may also be used particularly advantageously.

However, an embodiment of a force sensor as a deformation sensor, in particular as a capacitively operating deformation sensor, is also considered advantageous.

For improved reliability and increased measuring precision it is advantageous if the force sensor is embodied as a microsystem, for example extending less than 500 μm, in particular less than 100 μm, in one direction.

The transmission of energy or measured values to and/or from the force sensor can be carried out according to known transponder methods, for example by means of electromagnetic waves or inductive coupling. For example, the measured value transmitter receives electromagnetic waves, typically in the 100 kHz frequency range, from the transponder and uses their energy for its operation. The measured value transmitter in turn typically transmits 300 measured values per second back to the transponder.

As a result of the transmission of energy it is possible to dispense with an energy accumulator at the measured value transmitter.

The frequency of the signals which can be received by the measured value transmitter is advantageously different from the frequency at which the measured value transmitter transmits signals, with the result that signal interference does not occur.

It may also be advantageous if the measured value transmitter is equipped with an autonomous device for generating energy, for example a micromechanical device for converting the acceleration forces at the push rod into a voltage, for example by means of oscillating masses. As a result, a receiver for detecting the signals emitted by the measured value transmitter is sufficient.

It is also advantageous if the measured value transmitter is implemented with the force sensor within one component, in particular using microsystem technology.

A measured valued transmitter in the form of a surface wave component is preferred.

A combination of a capacitive extension sensor with a measured value transmitter made using surface wave technology (impedance loading) is particularly advantageous because it enables the sensor and measured value transmitter to be implemented without the use of electronic components on the push rod.

The crankshaft drive sensor can additionally include an evaluation unit by means of which measured values are evaluated, for example extension values into force values or force values and angles into other control variables, in particular a torque Md.

The crankshaft drive sensor can be used particularly advantageously in an internal combustion engine, preferably in a motor vehicle. Here, the push rod in the form of a connecting rod is rotatably connected to a cylinder piston on the one hand and to a crankshaft, on the other, as part of the drive train.

With the foregoing and other objects in view there is provided, in accordance with the invention a method of obtaining control variables for monitoring and/or controlling an internal combustion engine and/or a drive train, which includes steps of: mounting at least one force sensor on a push rod for providing measured values of a rod force; providing at least one measured value transmitter for transmitting the measured values of the force sensor in a contactless manner; providing an angle sensor for providing measured values of a crank angle of a crank connected to the push rod; and using corresponding ones of the measured values of the rod force and the measured values of the crank angle to derive control variables for performing an operation selected from the group consisting of monitoring an internal combustion engine, monitoring a drive train, controlling the internal combustion engine, and controlling the drive train.

In accordance with an added feature of the invention, a first control variable is derived which represents a torque acting on the crank.

In accordance with an additional feature of the invention, a second control variable is derived which represents a cylinder-specific force.

In accordance with a concomitant feature of the invention, a third control variable is derived which represents a profile of a pressure in a combustion chamber.

Other features which are considered as characteristic for the invention are set forth in the appended claims.

Although the invention is illustrated and described herein as embodied in a crankshaft drive sensor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a side view showing a part of an internal combustion engine which is equipped with an inventive crankshaft drive sensor; and

FIG. 2 shows, in sketch form, a diagram of the geometric system corresponding to FIG. 1 and the corresponding forces.

### DESCRIPTION OF THE PREFERRED EMBODIMENTS

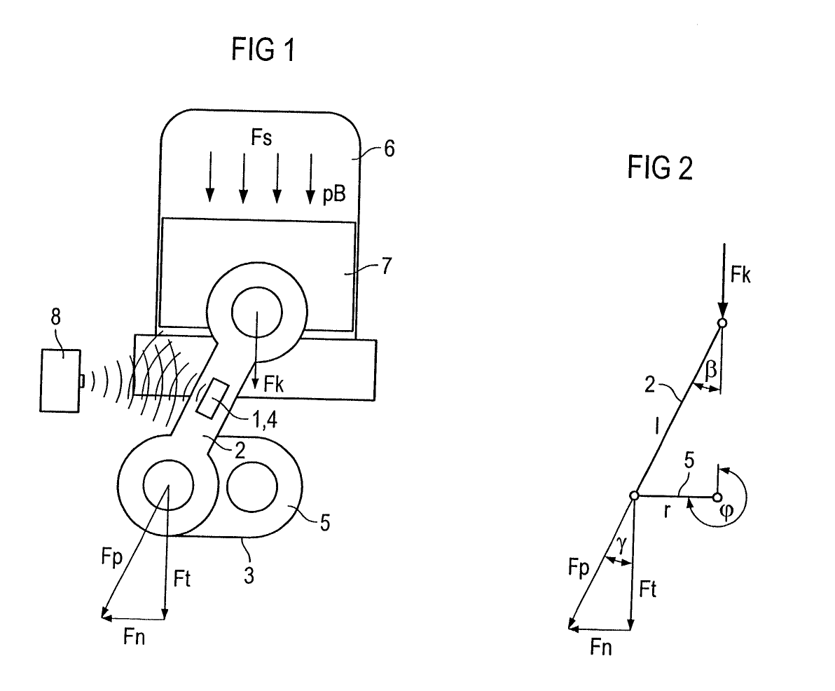

Referring now to the figures of the drawing in detail and first, particularly, to FIG. 1 thereof, there is shown a side view of a part of an internal combustion engine which is equipped with an inventive crankshaft drive sensor.

An air/fuel mixture is ignited in the combustion chamber 6 of an internal combustion engine, after which the pressure pB which is generated in the combustion chamber 6 presses down a cylinder piston 7, mounted so as to be movable in an axial direction therein, with a cylinder-specific force Fs.

A push rod in the form of a connecting rod 2 is rotatably mounted on the cylinder piston 7. The connecting rod 2 is respectively connected at its other end to a crankshaft 5.

This arrangement converts the linear up and down movement of the cylinder piston 7 into a circular rotary movement of the crankshaft 5.

A capacitive force sensor in the form of an extension sensor 1 and a measured value transmitter 4 made using microsystem technology are mounted on the connecting rod 2 in its longitudinal direction. The extension sensor 1 measures an extension of the connecting rod 2 along its longitudinal axis and passes on this measurement signal to the measured value transmitter 4. The measured data are transmitted in contactless fashion by the measured value transmitter 4 at regular intervals, typically 300/s, to a transponder 8 mounted at a remote location. The measured value transmitter 4 is embodied here using surface wave technology. The transponder 8 transmits microwave signals to the measured value transmitter 4 on one frequency and receives the measurement signals from it on another frequency.

A value of the rod force Fp is obtained from the extension value together with the cross section and the modulus of elasticity E of the push rod 2. A crank angle φ of the crankshaft 5 is determined at the same time as the value of the rod force Fp by means of an angle sensor 3. The push rod angle β, and also the piston force Fk, are obtained from the latter, together with the crank radius r and the push rod length l, in accordance with the following:

Fk=Fp·cos β. (1)

For knowledge of the inertial force F0:

F0=dv/dt·Mpl, (2)

where dv/dt is the acceleration of the push rod 2, which can be obtained from the rotational acceleration and angular position, and Mpl is the mass between the measurement point and cylinder piston 7. It follows that the pressure pB of the combustion chamber can be determined according to:

pB=Fs/Ak=(Fk+F0)/Ak, (3)

where Ak is the piston area of the cylinder piston 7. The torque Md acting on the crankshaft 5 can also be calculated according to:

Md=Ft·r=Fp sin(φ+β)·r. (4)

It is not necessary here to measure the angle φ directly but instead other angles, for example the push rod angle β or γ, can be determined and these are used to obtain the angle φ from distance and angle considerations with a given geometry.

Hereto, it is possible to determine easily:

the instantaneous overall torque by adding all of the coupling torques,

the cylinder-specific engine torque loss (friction+throttle loss) for determining the coupling torque during the thrust deactivation phase,

the overall engine torque loss by adding all of the cylinder-specific engine loss torques,

the calculation of the cylinder-specific gas torque (induced torque due to combustion) by adding the coupling torque and engine torque loss, and

the pressure profile in order to detect misfires, for controlling smooth running and for controlling the point of maximum combustion etc.

In this way, the crankshaft drive sensor can be used to derive directly virtually all control variables which according to contemporary criteria are of particular significance for engine control, in particular for CVT (“Continuous Variable Transmission”) gearboxes.

For example, the adaptation of the torque loss model can be carried out on the basis of the engine torque loss. The torque model can be adapted on the basis of the induced torque. Safety monitoring can be carried out in an emission control system on the basis of the measured clutch torque.

FIG. 2 shows, in sketch form, the diagram of the forces and distances corresponding to FIG. 1. A piston force Fk and a rod force Fp are exerted on the connecting rod 2 in accordance with the equation (1). The connecting rod 2 is at a push rod angle β relative to the perpendicular selected here as zero crossover. The connecting rod 2 is rotatably connected to the crankshaft 5 with a crank radius r. The crankshaft 5 has a crank angle φ about its axis of rotation. Thus FIG. 2 is an instantaneous representation in which the crankshaft 5 is horizontal.

The rod force Fp can be divided into a tangential component Ft=Fp cos γ which is perpendicular to the crankshaft 5 and to a corresponding normal component Fn. The torque Md exerted on the crankshaft 5 can be calculated from this in accordance with equation (4). In this instantaneous representation the angles β and γ are identical. As already stated above, other control variables in addition to the torque M can be derived.

In this way, a force sensor on the connecting rod 2 can be used to sense an effect of a chemical-mechanical energy conversion in a simple and noncritical way on a cylinder-specific basis, and virtually all of the important input variables for engine control can be derived.

We claim:

1. A crankshaft drive sensor, comprising:
at least one force sensor mounted on a push rod for measuring a rod force, said force sensor for providing a measurement signal;
at least one measured value transmitter for transmitting the measurement signal of said force sensor in a contactless manner; and
an angle sensor for determining a crank angle of a crank connected to the push rod.

2. The crankshaft drive sensor according to claim 1, wherein said force sensor is an extension sensor.

3. The crankshaft drive sensor according to claim 2, wherein said extension sensor is a component selected from the group consisting of a piezoresistive extension sensor, a capacitive extension sensor, and a surface wave component.

4. The crankshaft drive sensor according to claim 2, wherein said extension sensor is a vapor deposited high-temperature strain gage.

5. The crankshaft drive sensor according to claim 1, wherein said force sensor is a deformation sensor.

6. The crankshaft drive sensor according to claim 5, wherein said deformation sensor is a capacitive deformation sensor.

7. The crankshaft drive sensor according to claim 1, wherein said force sensor is embodied as a microsystem.

8. The crankshaft drive sensor according to claim 1, wherein said measured value transmitter can be powered using energy transferred from microwaves.

9. The crankshaft drive sensor according to claim 8, wherein said measured value transmitter operates at a transmission frequency and at a reception frequency that is different from the transmission frequency.

10. The crankshaft drive sensor according to claim 1, wherein said measured value transmitter includes a device for autonomously generating energy for powering internal operation.

11. A method of obtaining control variables for monitoring and/or controlling an internal combustion engine and/or a drive train, which comprises:
mounting at least one force sensor on a push rod for providing measured values of a rod force;
providing at least one measured value transmitter for transmitting the measured values of the force sensor in a contactless manner;
providing an angle sensor for providing measured values of a crank angle of a crank connected to the push rod; and
using corresponding ones of the measured values of the rod force and the measured values of the crank angle to derive control variables for performing an operation selected from the group consisting of monitoring an internal combustion engine, monitoring a drive train, controlling the internal combustion engine, and controlling the drive train.

12. The method according to claim 11, which comprises deriving a first control variable representing a torque acting on the crank.

13. The method according to claim 12, which comprises deriving a second control variable representing a cylinder-specific force.

14. The method according to claim 13, which comprises deriving a third control variable representing a profile of a pressure in a combustion chamber.

15. The method according to claim 11, which comprises deriving a second control variable representing a cylinder-specific force.

16. The method according to claim 11, which comprises deriving a third control variable representing a profile of a pressure in a combustion chamber.
